(19) United States
(12) Patent Application Publication
(10) Pub. No.: US 2026/0078775 A1
(43) Pub. Date: Mar. 19, 2026

(54) CONNECTION ASSEMBLY AND FAN

(71) Applicant: Ningbo Singfun Electric Appliance Co., Ltd., Cixi Ningbo (CN)

(72) Inventors: Yongyuan KUANG, Cixi Ningbo (CN); Yuchu YAO, Cixi Ningbo (CN); Huabing WANG, Cixi Ningbo (CN); Chuanshun CHEN, Cixi Ningbo (CN); Youhong ZHANG, Cixi Ningbo (CN)

(73) Assignee: Ningbo Singfun Electric Appliance Co., Ltd., Cixi Ningbo, ZH (CN)

(21) Appl. No.: 19/400,307

(22) Filed: Nov. 25, 2025

(30) Foreign Application Priority Data
Oct. 30, 2025 (CN) 2025223011292

(51) Int. Cl. F04D 29/60; F04D 25/08; F04D 29/00; F04D 29/054; F04D 29/12

(52) U.S. Cl. CPC F04D 29/601; F04D 25/08; F04D 29/002; F04D 29/054; F04D 29/122

(57) ABSTRACT

Disclosed are a connection assembly and a fan. The connection assembly includes a base assembly and a post assembly. The base assembly includes a first connection member and a first conductive piece. The post assembly includes a second connection member and a second conductive piece. The first connection member is rotatably connected to the second connection member, the first conductive piece and the second conductive piece are electrically connected after the first and second connection members are rotatably connected.

### PRIORITIES AND CROSS REFERENCES

This Application claims priority from Chinese Application No. 2025223011292 filed on 30 Oct. 2025, the teachings of which are incorporated by reference herein in their entirety.

### TECHNICAL FIELD

The present application relates to a connection assembly and a fan.

### BACKGROUND

The connection assemblies between a base and a post of existing fans are generally connected by thread. For example, Chinese patent CN111682335A discloses a plug-in connected fan, in which a lower mating plate is arranged in the base, an upper mating plate is arranged in the post, a spring pin is arranged at the bottom of the upper mating plate, and a contactor is provided on the opposite sides of the lower mating plate and the upper mating plate. The post is arranged on the base by a threaded fit of a tube cap and a triangular nut, so that the spring pin and the contactor are connected in a plug-in form. In this scheme, a threaded connection between the post and the base by a triangular nut is needed, the structure of which is complex and inconvenient to disassemble and assemble, which would increase the costs and is not favorable for the package and transportation. In addition, this plug-in electrical connection requires to plug firstly and then to rotate, which would make the plug-in pieces prone to sprain damage during rotation due to the friction between the contacting surfaces or the force applied by the operator, resulting in poor user experience. Also, the threaded connection does not allow additional sealing components to be arranged on the threaded connection surfaces, otherwise the threaded rotation will not be possible, resulting in air leakage on the threaded connection surfaces.

### SUMMARY OF THE DISCLOSURE

The purpose of the present application is to provide a connection assembly and a fan, in which an electrically connected solution is achieved after rotating related parts, which is intended to solve the problems of complex structure, poor sealing and easily damage caused to the plug-in parts due to the need of rotating operation after plugging operation in the existing connection assemblies.

The present application relates to a connection assembly comprising:
a base assembly, comprising a first connection member and a first conductive piece; and
a post assembly, comprising a second connection member and a second conductive piece,
wherein, the first connection member is rotatably connected with the second connection member, the first conductive piece and the second conductive piece are electrically connected after the first and second connection members are rotatably connected.

Herein, a first air passage is provided in the first connection member and a second air passage is provided in the second connection member. When the first connection member is rotatably connected with the second connection member, the first air passage is in communication with the second air passage. The first connection member may be detachably connected to the second connection member by a coupling structure. The coupling structure may include a coupling slot and a protrusion, the protrusion is matedly engaged with the coupling slot. The first connection member may be a support frame, the second connection member may be a connection seat, the first conductive piece may be arranged on the support frame, the second conductive piece may be arranged on the connection seat. The first conductive piece may be an electric contact plate, and the second conductive piece may be a conductive plate, which is mounted onto the connection seat by a pressing plate. The base assembly may also include a sealing ring, which is arranged on the support frame, and the electric contact plate may be clamped between the sealing ring and the support frame. A limit element may also be provided between the support frame and the connection seat. A seal may also be provided between the first connection member and the second connection member.

The present application also provides a fan, including the connection assembly as described above, and a blower may further be provided in the base assembly.

In some embodiments, the fan may further include an air supply member, and the post assembly may include a post, on which the air supply member is arranged. The base assembly may also include a base housing, in which the first connection member is arranged. A blower may be also provided in the base housing.

By providing the first connection member and the second connection member to be firstly rotated and then electrically connected, the connection assembly provided in the present application can facilitate disassembly and assembly, facilitate package and transportation, which can avoid the existing problem of frictional or torsional damage between the plug-in pieces due to rotation. It can also improve the sealing between the first connection member and the second connection member, making it possible to arrange a seal on the connection surfaces, and improving the sealing effect of the air passages that are connected in the first connection member and the second connection member. By using the connection assembly as described above, the fan provided in the present application can simplify structure of the product, reduce costs, facilitate package and transportation of the product, and can effectively improve the air supply effect and enhance the using experience thereof.

### BRIEF DESCRIPTION OF THE DRAWINGS

FIG. 1 is a first schematic view of a fan of the present application.

FIG. 2 is a second schematic view of a fan of the present application.

FIG. 3 is a first exploded schematic view of a fan of the present application.

FIG. 4 is a second exploded schematic view of a fan of the present application.

FIG. 5 is a third exploded schematic view of a fan of the present application.

FIG. 6 is a partially exploded view of the post assembly of the present application.

FIG. 7 is a front schematic view of the post base of the present application.

FIG. 8 is a back schematic view of the post base of the present application.

FIG. 9 is a schematic view of the fit between the base support frame and the upper cover of the present application.

FIG. 10 is a schematic view of the silicone pad of the present application.

FIG. 11 is a schematic view of the base support frame of the present application.

FIG. 12 is a sectional view of the connection assembly of the present application.

In which: 1. base assembly; 11. base housing; 12. upper cover; 13. support frame; 131. support wall; 132. socket slot; 133 catch slot; 14. sealing ring; 141. open slot; 15. electric contact plate; 16. limit pin; 17. spring; d 18. first air passage; 2. post assembly; 21. post; 22. post base; 221. protrusion; 222 limit slot; 23. conductive plate; 231. copper pin; 24. pressing plate; 25. connection seat; 251. second air passage; 3. air supply member.

### DETAILED DESCRIPTION

To make the purpose, technical solution and advantages of the present application clearer, the embodiments of the present application will be described in detail with reference to the drawings below. It should be noted that, in the absence of conflict, the embodiments of the present application and the features of the embodiments may be combined arbitrarily with each other.

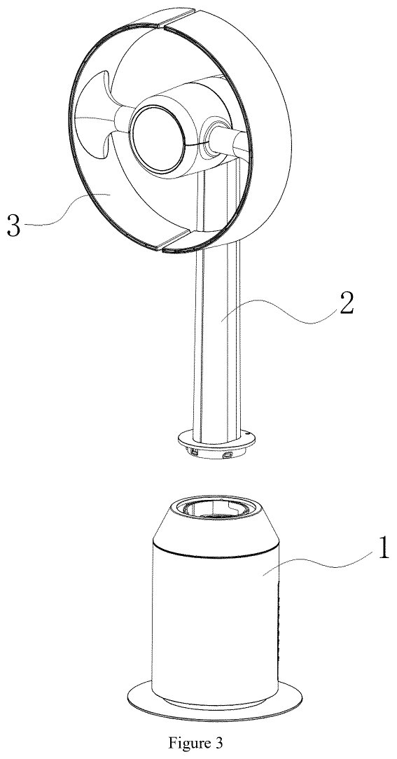

As shown in FIGS. 3-5, the present application provides a connection assembly which includes a base assembly 1 and a post assembly 2. Herein, the base assembly 1 includes a first connection member and a first conductive piece, with the first conductive piece arranged on the first connection member. The post assembly 2 includes a second connection member and a second conductive piece, with the second conductive piece arranged on the second connection member. Specifically, the first connection member is rotatably connected to the second connection member so that the first conductive piece and the second conductive piece are electrically connected. By providing the first and second connection members to be directly connected by rotation, the connection assembly provided in the present application is convenient to disassembly and assembly, easy for package and transportation, which has a relatively simple and practical structure and can simply achieve electrical connection.

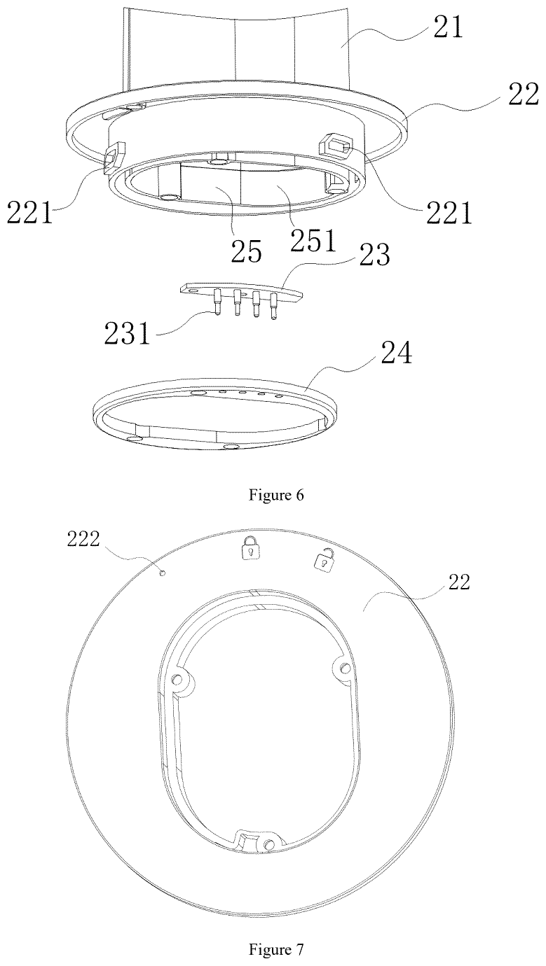

As shown in FIG. 9, in some embodiments, the first connection member is a support frame 13, with a first air passage 18 provided in the first connection member. Correspondingly, as shown in FIG. 6, the second connection member is a connection seat 25, with a second air passage 251 provided in the second connection member. Specifically, when the support frame 13 and the connection seat 25 are coupled together by rotation, the first air passage 18 is in communication with the second air passage 251 for achieving air guiding. Further, the post assembly 2 also includes a post 21, an air passage in which is in communication with the second air passage 251 of the connection seat 25. The connection assembly provided in the present application, by rotating and coupling the first and second connection members, can provide better sealing between the first and second connection members compared to a threaded connection, thereby avoiding air leakage between the air passages in the first and second connection members. Preferably, a seal may also be arranged between the first connection member and the second connection member to improve the sealing effect there-between.

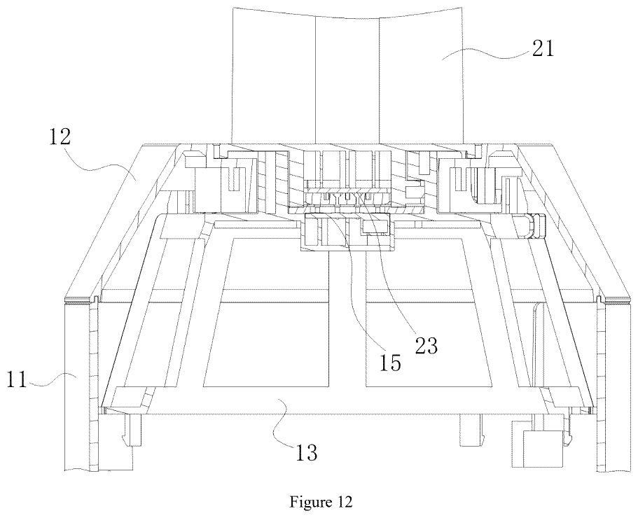

As shown in FIGS. 6, 9, 11 and 12, in some embodiments, the first connection member is a support frame 13, which is provided with a support wall 131. The first air passage is vertically arranged at the center position of the support frame 13 and located inside the support wall 131. The second connection member is a connection seat 25, and the second air passage is vertically arranged at the center position of the connection seat 25. The support wall 131 and the connection seat 25 are detachably coupled together by a coupling structure. Specifically, the coupling structure includes a coupling slot and a protrusion 221 which are matedly connected. Specifically, for example, the coupling slot is arranged on the side wall of the support wall 131, and the protrusion 221 is arranged on the side wall of the connection seat 25. Further, the coupling slot includes a socket slot 132 and a catch slot 133, preferably the socket slot 132 and the catch slot 133 may be communicated with each other. The protrusion 221 could be inserted vertically into the socket slot 132 and be rotated clockwise to couple with the catch slot 133, thus achieving a sealed connection. Preferably, at least three protrusions 221 are provided to improve the stability and sealing of the coupling. With the above scheme, the support frame 13 and the connection seat 25 are coupled together by insertion and rotation, which could achieve a sealed connection and prevent air leakage in the air passages.

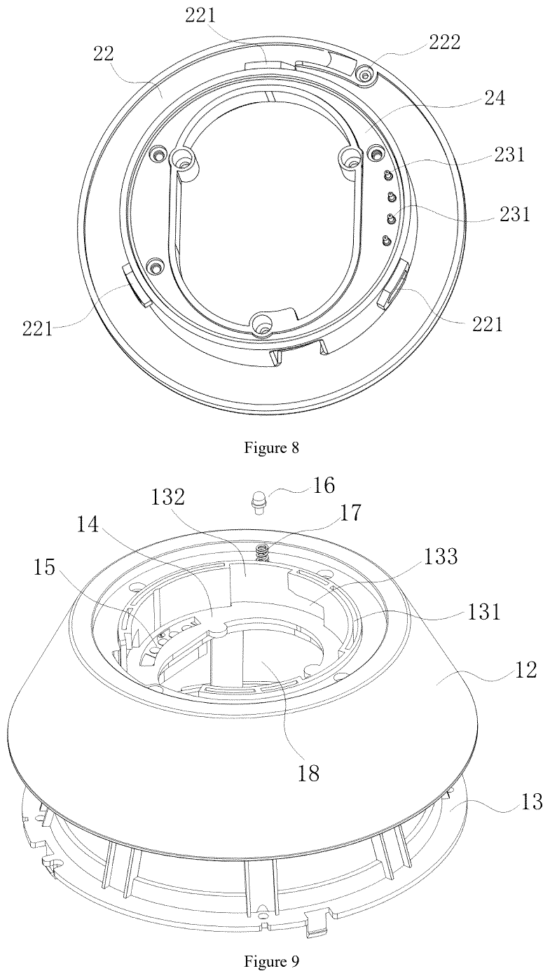

As shown in FIGS. 6, 8, 9, and 12, in some embodiments, the first conductive piece is arranged on the support frame 13 and the second conductive piece is arranged on the connection seat 25. Specifically, the first conductive piece is an electric contact plate 15, which can be a copper plate. The electric contact plate 15 is arranged on the support frame 13 and may be arranged on the end surface inside the support wall 131. The second conductive piece is a conductive plate 23, which is arranged on the connection seat 25 and may be arranged on the bottom surface of the connection seat 25. Specifically, the electric contact plate 15 is provided with an electric contact slot, and the conductive plate 23 is provided with a retractable copper pin 231. With the above scheme, when the connection seat 25 is coupled together with the support frame 13 by rotation, the copper pin 231 can be electrically connected with the electric contact slot by being rotated to the position of the electric contact slot and contacted with the electric contact slot.

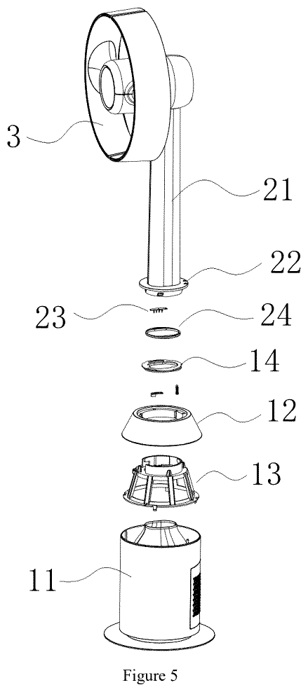

As shown in FIGS. 5, 6, and 8, in some embodiments, the post assembly 2 further includes a pressing plate 24 for the conductive plate, which is mounted onto the connection seat 25, and the conductive plate 23 is thus clamped between the pressing plate 24 and the connection seat 25. Preferably, the pressing plate 24 is a ring-shaped structure with a through hole provided therein, allowing the copper pin 231 to be able to pass through the through hole. Using the above scheme, the conductive plate 23 is mounted onto the connection seat 25 by providing the pressing plate 24, which makes the connection and fixation of the conductive plate 23 more reliable and further enhances the strength of the connection seat 25, thereby avoiding damage caused by excessive rotation of the connection seat 25.

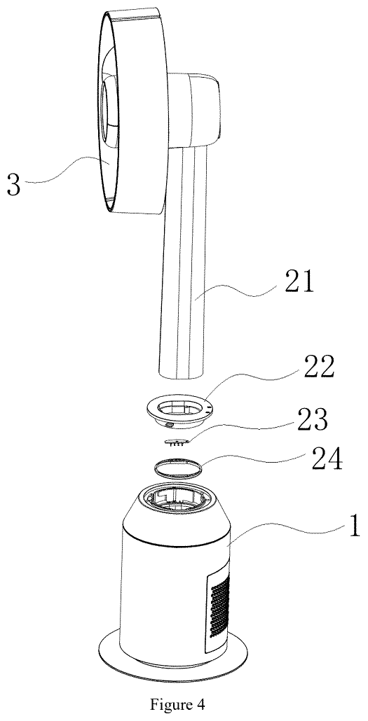

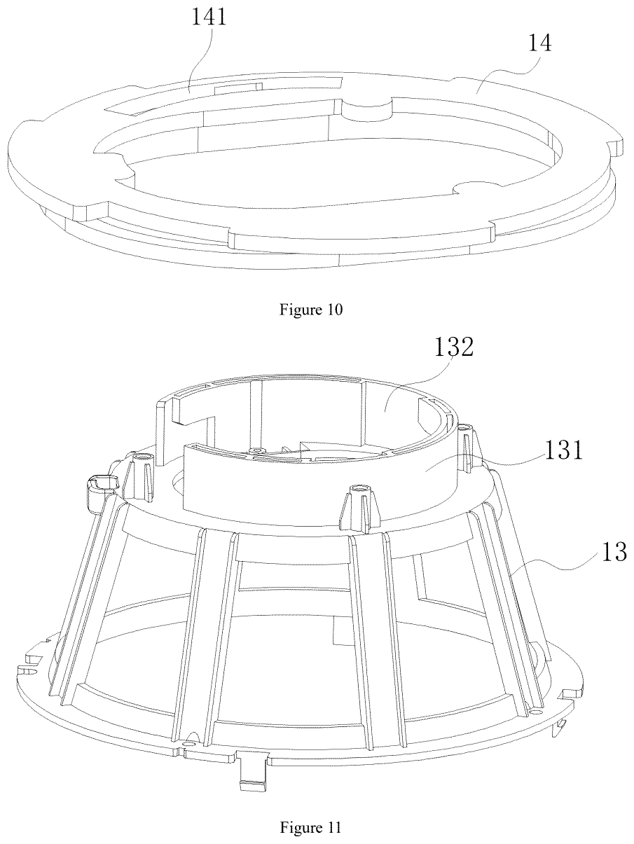

As shown in FIGS. 4, 5, and 9, in some embodiments, the base assembly 1 further includes a sealing ring 14, which may be a silicone ring. The sealing ring 14 is arranged on the support frame 13, and the electric contact plate 15 is clamped between the sealing ring 14 and the support frame 13, so that the support frame 13 and the connection seat 25 can fit tightly when being coupled, thereby avoiding the air leakage in the air passages between the support frame 13 and the connection seat 25. Specifically, the electric contact plate 15 may be clamped between the sealing ring 14 and the end surface of the support frame 13. As shown in FIG. 10, the sealing ring 14 is provided with an open slot 141 which fits with the electric contact plate 15, allowing the copper pin 231 on the conductive plate 23 to be able to pass through the open slot 141 and contact with the electric contact plate 15.

As shown in FIGS. 7-9, in some embodiments, in order to prevent an accidental disassembly between the support frame 13 and the connection seat 25, the support frame 13 and the connection seat 25 may be also detachably connected by a limit element, which can prevent a maloperation. An unlock and lock marks may be provided on the post base 22. Specifically, the limit element includes an elastic limit pin 16 and a limit slot 222 which are fitted with each other. Preferably, the limit slot 222 is arranged on the post base 22 and is opposite to the limit pin 16. The limit pin 16 is arranged on the support frame 13, the limit pin 16 can be stretched and retracted elastically relative to the support frame 13. With the above scheme, when the connection seat 25 are rotated to the preset angle to couple with the support frame 13, the limit pin 16 can be coupled with the limit slot 222, so as to achieve tightly locking. When need to be unlocked, the limit pin 16 could be pushed out of the limit slot 222 through compressing the limit pin 16 by an insert along the limit slot 222, and then rotating the connection seat 25, so as to achieve unlocking.

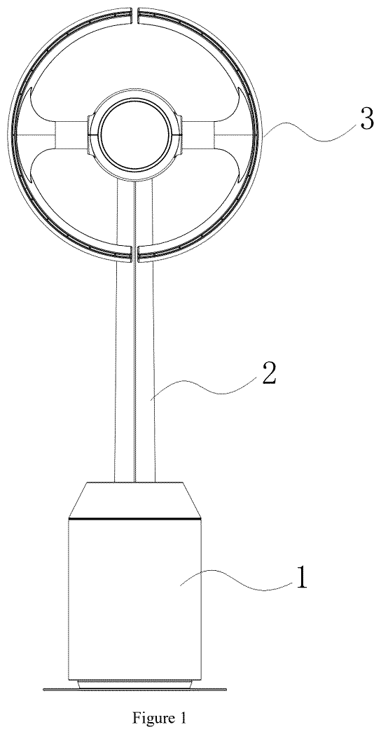

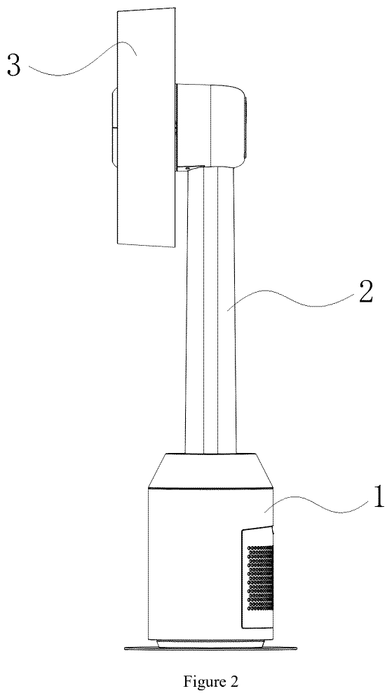

As shown in FIGS. 1-5, the present application also provides a fan, including a connection assembly, which is the connection assembly mentioned above. Preferably, the fan provided in the present application is a bladeless fan, and the connection assembly may be arranged at the connection between the base and the post, or at the connection between the base or the post and the fan blade assembly, or any other position suitable for rotating and electrically connecting.

As shown in FIGS. 1-5, in some embodiments, the fan also includes an air supply member 3. The post assembly 2 includes a post 21 and a post base 22, with the post 21 arranged on the post base 22 and with the air supply member 3 arranged on the post 21. An air passage in the post 21 is in communication with an air passage in the post base 22, and an air passage in the air supply member 3 is in communication with the air passage in the post 21. The base assembly 1 also includes a base housing 11 and an upper cover 12. The first connection member is arranged in the base housing 11, and an air inlet is also provided on the side surface of the base housing 11. The upper cover 12 is covered and arranged on the support frame 13. The base housing 11 is provided with a blower therein, which can be rotated to create an airflow into the first air passage of the first connection member.

By providing the first connection member and the second connection member to be directly connected by rotation, the connection assembly provided in the present application can facilitate the disassembly and assembly, facilitate the package and transportation, and achieve an electrical connection. It can also improve the sealing between the first connection member and the second connection member, resulting in better sealing of the air passages that are connected in the first connection member and the second connection member.

By using the above-mentioned connection assembly, the fan provided in the present application can simplify structure of the product, reduce costs, facilitate package and transportation of the product, and can effectively improve the air supply effect and enhance the using experience thereof.

Although the embodiments disclosed in the present application are described as above, the contents are only embodiments adopted for the purpose of understanding the present application and are not intended to limit the present application. Any person skilled in the art to which the application pertains may, without departing from the spirit and scope disclosed in the application, can make any modifications and changes in the forms and details to be embodied, but the scope of the patent protection of the application shall be subject to the scope defined in the appended claims.

1. A connection assembly, comprising:
a base assembly, comprising a first connection member and a first conductive piece; and
a post assembly, comprising a second connection member and a second conductive piece,
wherein, the first connection member is rotatably connected with the second connection member, the first conductive piece and the second conductive piece are electrically connected after the first and second connection members are rotatably connected.

2. The connection assembly according to claim 1, wherein, a first air passage is provided in the first connection member and a second air passage is provided in the second connection member; when the first connection member is rotatably connected with the second connection member, the first air passage is in communication with the second air passage.

3. The connection assembly according to claim 1, wherein, the first connection member is detachably connected to the second connection member by a coupling structure, which comprises a coupling slot and a protrusion; the protrusion is matedly engaged with the coupling slot.

4. The connection assembly according to claim 3, wherein, the first connection member is a support frame, the second connection member is a connection seat, the first conductive piece is arranged on the support frame, the second conductive piece is arranged on the connection seat.

5. The connection assembly according to claim 4, wherein, the first conductive piece is an electric contact plate, the second conductive piece is a conductive plate, and the conductive plate is mounted onto the connection seat by a pressing plate.

6. The connection assembly according to claim 5, wherein, the base assembly further comprises a sealing ring, the sealing ring is arranged on the support frame, the electric contact plate is clamped between the sealing ring and the support frame.

7. The connection assembly according to claim 4, wherein, a limit element is further provided between the support frame and the connection seat.

8. The connection assembly according to claim 1, wherein, a seal is further provided between the first connection member and the second connection member.

9. A fan comprising a connection assembly, wherein, the connection assembly is the connection assembly according to claim 1.

10. The fan according to claim 9, wherein, a blower is further provided in the base assembly.

11. The fan according to claim 9, wherein, the first connection member is a support frame, the second connection member is a connection seat, the first conductive piece is arranged on the support frame, the second conductive piece is arranged on the connection seat.

12. The fan according to claim 11, wherein, the first conductive piece is an electric contact plate, the second conductive piece is a conductive plate, and the conductive plate is mounted onto the connection seat by a pressing plate.

13. The fan according to claim 12, wherein, the base assembly further comprises a sealing ring, the sealing ring is arranged on the support frame, the electric contact plate is clamped between the sealing ring and the support frame.

14. The fan according to claim 11, wherein, a limit element is further provided between the support frame and the connection seat.

15. The fan according to claim 9, wherein, a seal is further provided between the first connection member and the second connection member.

16. A fan comprising a connection assembly, wherein, the connection assembly is the connection assembly according to claim 4.

17. The fan according to claim 16, wherein, the first conductive piece is an electric contact plate, the second conductive piece is a conductive plate, and the conductive plate is mounted onto the connection seat by a pressing plate.

18. The fan according to claim 17, wherein, the base assembly further comprises a sealing ring, the sealing ring is arranged on the support frame, the electric contact plate is clamped between the sealing ring and the support frame.

19. The fan according to claim 16, wherein, a limit element is further provided between the support frame and the connection seat.

20. The fan according to claim 16, wherein, a seal is further provided between the first connection member and the second connection member.
